(19) United States
(12) Patent Application Publication
(10) Pub. No.: US 2023/0193031 A1
(43) Pub. Date: Jun. 22, 2023

(54) POLYETHYLENE-ESTER BOTTOMS MODIFIED ASPHALT COMPOSITIONS AND METHODS OF MAKING AND USING THEREOF

(71) Applicant: MARATHON PETROLEUM COMPANY LP, Findlay, OH (US)

(72) Inventors: Cristian S. Clopotel, Findlay, OH (US); Anas A. Jamrah, Findlay, OH (US); Brian K. Wilt, Findlay, OH (US); Stormy R. Brewster, Findlay, OH (US)

(21) Appl. No.: 18/082,057

(22) Filed: Dec. 15, 2022

Related U.S. Application Data
(60) Provisional application No. 63/265,551, filed on Dec. 16, 2021.

(51) Int. Cl. C08L 95/00; C08L 23/06

(52) U.S. Cl. CPC C08L 95/00; C08L 23/06; C08L 2555/64; C08L 2555/86

(57) ABSTRACT

Methods and compositions for the production of polyethylene-ester bottoms modified asphalt are provided. These compositions reduce the fire and explosion hazard risks associated with the use of polyethylene. As these methods and compositions involve consumption of ester bottoms, a waste byproduct of refining, they provide sustainable asphalt materials.

### CROSS REFERENCE TO RELATED APPLICATIONS

This application claims priority to, and the benefit of U.S. Provisional Application No. 63/265,551, filed Dec. 16, 2021, titled “POLYETHYLENE-MODIFIED ASPHALT METHODS AND COMPOSITONS FOR ENHANCING LOW TEMPERATURE PERFORMANCE,” the disclosure of which is incorporated herein by reference in its entirety.

### TECHNICAL FIELD

The present disclosure relates to polyethylene-ester bottoms modified asphalt compositions and methods of making these compositions to reduce fire and explosion hazards.

### BACKGROUND

The refining industry has struggled with enhancing useable temperature ranges (UTRs) of asphalt. In areas of high loading or slow or standing traffic as well as areas where temperature extremes can be experienced in excess of 86° C. between high and low temperature levels, the asphalt requires the use of modifiers to obtain an increased UTRs. As a result, it has been common to start with softer asphalts to reach low temperature properties, while adding modifiers such as polymers to enhance temperature performance. Polymers, such as polyethylene, are often used as modifiers in asphalt. While the usage of polyethylene is shown to enhance high temperature compliance, low temperature compliance may be reversely affected. In addition to the decrease in low temperature compliance, polyethylene in the form of powder may create risk associated with fire and explosion hazards.

### SUMMARY

Provided here are compositions and methods to address these shortcomings of the art and provide other additional or alternative advantages. Applicant has recognized risks associated with fire and explosion hazards and low temperature compliance related to a modified asphalt composition that has the addition of a polymer to affect low temperature compliance. The present disclosure generally is directed to embodiments of methods of producing a polyethylene-ester bottoms modified asphalt compositions that address these shortcomings of the art and provide other additional or alternative advantages.

Moreover, the addition of ester bottoms to asphalt provides refiners an opportunity to use low value by-product waste of refining methyl ester, including biodiesel. Rather than utilizing additional products capable of achieving the necessary temperature compliance of the unmodified asphalt, refineries recycle ester bottoms, a waste byproduct of refining, effectively providing cost saving to the refinery.

Blending polyethylene with ester bottoms, prior to mixing the polymer with unmodified asphalt, reduces fire and explosion hazard associated with the use of polyethylene, maintains or does not substantially affect the high temperature compliance, and improves the low temperature compliance of the asphalt. Although there are changes in the high and low temperature compliance of the asphalt with the addition of polyethylene-ester bottoms mixture, the UTR performance grading of the polyethylene-ester bottoms modified asphalt remains the same as the unmodified asphalt.

In certain embodiments, the methods for producing a polyethylene-ester bottoms modified asphalt include blending polyethylene with ester bottoms to form a polyethylene-ester bottoms mixture. The polyethylene-ester bottoms mixture may contain about 0.5 weight percent (wt. %) to about 75 wt. % of polyethylene. The method may further include mixing the polyethylene-ester bottoms mixture with an unmodified asphalt to produce a polyethylene-ester bottoms modified asphalt. The ester bottoms may be a byproduct of methyl ester refining. The ester bottoms may contain one or more of methyl esters, sodium soap, monoglycerides, diglycerides, triglycerides, or unsaponifiables. The method may further include the following steps to obtain the ester bottoms: reacting methanol and dry oil to generate reaction products with at least methyl ester and glycerin, removing at least a portion of the glycerin from the reaction products to leave an ester phase, and distilling the ester phase to separate purified methyl esters and recover distillation bottoms as ester bottoms. The dry oil may include one or more of a vegetable oil or an animal fat that has at least some moisture removed therefrom prior to reaction with the methanol.

The polyethylene-ester bottoms modified asphalt may contain about 80 wt. % to about 99 wt. % of the unmodified asphalt. The polyethylene-ester bottoms modified asphalt may also contain about 1 wt. % to about 20 wt. % of the polyethylene-ester bottoms mixture. The polyethylene-ester bottoms mixture may contain about 50 wt. % of the polyethylene. The polyethylene-ester bottoms mixture may contain about 75 wt. % of the polyethylene. In certain embodiments, a low temperature compliance of the polyethylene-ester bottoms modified asphalt as measured by a m-value may be up to 10% greater than a low temperature compliance of a polyethylene modified asphalt. In certain embodiments, a low temperature compliance of the polyethylene-ester bottoms modified asphalt as measured by a m-value may be up to 5% greater than a low temperature compliance of a polyethylene modified asphalt. The m-value measures the rate at which the asphalt binder stiffness changes over time. The m-value is used to determine low temperature compliance. A higher m-value is an indication that the stiffness may not increase as quickly when temperature decreases. The polyethylene may be blended with the ester bottoms at a temperature ranging from about 15 degrees Celsius (° C.) to about 24° C.

In certain embodiments, a method of producing a polyethylene-ester bottoms modified asphalt may include mixing a polyethylene-ester bottoms mixture that contains polyethylene and ester bottoms with an unmodified asphalt to produce a polyethylene-ester bottoms modified asphalt. The method may further include the following steps: reacting methanol and dry oil to generate reaction products with at least methyl ester and glycerin, removing at least a portion of the glycerin from the reaction products to leave an ester phase; and distilling the ester phase to separate purified methyl esters and recover distillation bottoms as ester bottoms. The dry oil may include one or more of a vegetable oil or an animal fat that has at least some moisture removed therefrom prior to reaction with the methanol. The polyethylene-ester bottoms modified asphalt may contain about 1 wt. % to about 20 wt. % of the polyethylene-ester bottoms mixture. The polyethylene-ester bottoms mixture may contain about 0.5 wt. % to about 75 wt. % of the polyethylene. The polyethylene-ester bottoms mixture may contain about 50 wt. % of the polyethylene. The ester bottoms may be a byproduct of methyl ester refining. The ester bottoms may contain one or more of methyl esters, sodium soap, monoglycerides, diglycerides, triglycerides, or unsaponifiables. In certain embodiments, a low temperature compliance of the polyethylene-ester bottoms modified asphalt as measured by a m-value may be up to 10% greater than a low temperature compliance of a polyethylene modified asphalt. In certain embodiments, a low temperature compliance of the polyethylene-ester bottoms modified asphalt as measured by a m-value may be up to 5% greater than a low temperature compliance of a polyethylene modified asphalt. The polyethylene-ester bottoms mixture may contain about 75 wt. % of the polyethylene. In certain embodiments, a low temperature compliance of the polyethylene-ester bottoms modified asphalt as measured by a m-value is 1% greater than a low temperature compliance of a polyethylene modified asphalt.

In certain embodiments, a polyethylene-ester bottoms modified asphalt composition contains about 80 wt. % to about 99 wt. % of an unmodified asphalt. The composition also contains about 1 wt. % to about 20 wt. % of a polyethylene-ester bottoms mixture. The polyethylene-ester bottoms mixture may contain about 50 wt. % to about 75 wt. % of the polyethylene. The ester bottoms may be a byproduct of methyl ester refining. The ester bottoms may be obtained as distillation bottoms of a distilled methyl ester product that results from reaction between methanol and at least one of vegetable oil or animal fat from which glycerin is settled and removed from the methyl ester product prior to distillation.

### BRIEF DESCRIPTION OF DRAWINGS

These embodiments and other features, aspects, and advantages of the disclosure will be better understood in conjunction with the following descriptions, claims, and accompanying drawings. It is to be noted, however, that the drawings illustrate only certain embodiments of the disclosure and, therefore, are not to be considered limiting of the scope of the disclosure.

FIG. 1 is an illustrative block diagram for producing polyethylene-ester bottoms modified asphalt from polyethylene, ester bottoms, and unmodified asphalt, according to an embodiment of the disclosure.

FIG. 2 is a diagrammatic representation of the method of production of polyethylene-ester bottoms modified asphalt from polyethylene, ester bottoms, and unmodified asphalt, according to an embodiment of the disclosure.

FIG. 3 is a graphical representation of a comparison of m-values of unmodified asphalt, polyethylene modified asphalt, and variations of polyethylene-ester bottoms modified asphalt, according to an embodiment of the disclosure.

FIG. 4 is a graphical representation of a comparison of high temperature compliance of polyethylene modified asphalt and variations of polyethylene-ester bottoms modified asphalt measured as original binder (unaged binder) and rolling thin-film oven aged binders, according to an embodiment of the disclosure.

### DETAILED DESCRIPTION

So that the manner in which the features and advantages of the embodiments of the compositions and methods disclosed herein, as well as others, which will become apparent, may be understood in more detail, a more particular description of embodiments of compositions and methods is provided. In the following description, numerous details are set forth in order to provide a thorough understanding of the various embodiments. In other instances, well-known processes, devices, and systems may not been described in particular detail in order not to unnecessarily obscure the various embodiments. Additionally, illustrations of the various embodiments may omit certain features or details in order to not obscure the various embodiments.

The present disclosure is directed to polyethylene-ester bottoms modified asphalt compositions and methods for the production of these polyethylene-ester bottoms modified asphalts. Use of these compositions reduces or eliminates fire and explosion hazards associated with polyethylene and improves the low temperature compliance of asphalt. Certain embodiments include compositions that contain unmodified asphalt and a polyethylene-ester bottoms mixture. Other embodiments include methods for producing the polyethylene-ester bottoms modified asphalt based on unmodified asphalt and a polyethylene-ester bottoms mixture. The polyethylene-ester bottoms mixture may increase the m-value of the asphalt composition. The performance grading of the polyethylene-ester bottoms modified asphalt remains the same as unmodified asphalt.

The terms “unmodified asphalt”, “neat asphalt”, “asphalt”, “asphalt composition”, “asphalt cement”, or “asphalt binder” are used synonymously to refer to a complex mixture of organic materials, solid or semi-solid at ambient temperature, which gradually liquefy when heated, and in which the main constituents are bituminous substances obtained from natural sources or derived from a number of sources such as petroleum, shale oil, coal tar, and the like, as well as the mixtures of two or more of such materials. Solvent deasphalting or distillation may produce the asphalt. For example, vacuum tower bottoms produced during the refining of conventional or synthetic petroleum oils is a common residue material useful as an asphalt composition. A “paving asphalt composition”, “paving asphalt cement”, or “paving asphalt binder”, accordingly is an asphalt composition or asphalt cement having characteristics which dispose the composition to use as a paving material. This is contrasted, for example, with an asphalt composition suited for use as a roofing material. “Roofing asphalts”, usually have a higher softening point and are thus more resistant to flow from heat on roofs. The higher softening point is generally imparted by the air blowing processes by which they are commonly produced. Paving asphalt mixtures may be formed and applied in a variety of ways, as understood by those skilled in the art.

Unmodified asphalt may be obtained directly from the refinery. As used herein, an unmodified asphalt may have other modifiers but does not contain a polymer modifier. The type of asphalt used will depend on the particular application intended for the resulting bitumen composition. In certain embodiments, materials may have an initial viscosity at 60° C. of 200 to 6000 poise. The initial penetration range of the base asphalt at 25° C. is 30 to 350 decimillimeter (dmm), or about 50 to 200 dmm, when the intended use of the composition is road paving.

Solvent deasphalting (SDA) bottoms may be used as part or all of the asphalt of the product blend. SDA bottoms are obtained from suitable feeds such as vacuum tower bottoms, reduced crude (atmospheric), topped crude, and hydrocarbons comprising an initial boiling point of about 450° C. or above. In certain embodiments, the SDA bottoms contain hydrocarbons comprising an initial boiling point of about 500° C. or above, or about 540° C. or above. The SDA bottoms are obtained from vacuum tower bottoms. Solvent deasphalting can be carried out at temperatures of 93-148° C. After solvent deasphalting, the resulting SDA bottoms have a boiling point above 510° C. and a penetration of 0 to 70 dmm at 25° C. The type of asphalt used will depend on the particular application intended for the resulting bitumen composition. In certain embodiments, materials have an initial viscosity at 60° C. of 200 to 6000 poises, or about 250 to 4000 poises. The initial penetration range of the base asphalt at 25° C. is 30 to 350 decimillimeter (dmm), or about 50 to 200 dmm, when the intended use of the composition is road paving.

The asphalt composition may be solely or partly material produced by distillation, without any solvent extraction step. Such materials sometimes referred to as “asphalt cement”, have a reduced viscosity relative to SDA bottoms. Such asphalt cement component can have a viscosity of 100 to 5000 poises at 60° C. The asphalt cement component is added in amounts sufficient to provide the resulting asphalt composition with the desired viscosity for the intended application, e.g., 2000 poises at 60° C. for paving applications. For Performance Graded (PG) applications, the asphalt compositions will have a G*/sin delta value in excess of 1.0 kPa at temperatures ranging from 46 to 82° C. The asphalt cement component of reduced viscosity may be obtained from any suitable source, e.g., atmospheric distillation bottoms.

Certain embodiments include compositions that contain unmodified asphalt and a polyethylene-ester bottoms mixture. The polyethylene-ester bottoms mixture may contain about 25 wt. % to about 99.5 wt. % of ester bottoms. In certain embodiments, a polyethylene-ester bottoms mixture may contain about 25 wt. % to about 95.5 wt. % of ester bottoms, or about 20 wt. % to about 90 wt. %, or about 25 wt. % to about 85.5 wt. %, or about 30 wt. % to about 80 wt. %, or about 25 wt. % to about 75 wt. %, or about 25 wt. % to about 65 wt. %, or about 30 wt. % to about 65 wt. %, or about 30 wt. % to about 65 wt. %, or about 35 wt. % to about 65 wt. %, or about 40 wt. % to about 65 wt. %, or about 45 wt. % to about 65 wt. %, or about 45 wt. % to about 55 wt. %, or about 25 wt. %, or about 35 wt. %, or about 40 wt. %, or about 42 wt. %, or about 45 wt. %, or about 50 wt. %.

The polyethylene-ester bottoms mixture may also contain about 0.5 wt. % to about 75 wt. % of polyethylene. In certain embodiments, a polyethylene-ester bottoms mixture may contain about 1.5 wt. % to about 70 wt. % of polyethylene, or about 5 wt. % to about 75 wt. %, or about 15 wt. % to about 75 wt. %, or about 20 wt. % to about 70 wt. %, or about 25 wt. % to about 75 wt. %, or about 25 wt. % to about 65 wt. %, or about 30 wt. % to about 65 wt. %, or about 30 wt. % to about 65 wt. %, or about 35 wt. % to about 65 wt. %, or about 40 wt. % to about 65 wt. %, or about 45 wt. % to about 65 wt. %, or about 45 wt. % to about 55 wt. %, or about 40 wt. %, or about 45 wt. %, or about 50 wt. %, or about 52 wt. %, or about 55 wt. %, or about 60 wt. %, or about 65 wt. %, or about 70 wt. %, or about 75 wt. %.

The term “about” refers an acceptable error for a particular value as determined by one of ordinary skill in the art using measurements in accordance with the referenced standards for the experiments. In embodiments, “about” may include values within a standard deviation of a specified value, which depends in part on how the value is measured or determined. In one non-limiting embodiment, when the term “about” is used with a particular value, then “about” refers to a range extending to ±10% of the specified value, alternatively ±5% of the specified value, or alternatively ±1% of the specified value, or alternatively ±0.5% of the specified value. In embodiments, “about” refers to the specified value.

Polyethylene is used to modify the asphalt. Other polymers may be used along with polyethylene for modifying asphalts include: Styrene Butadiene (SB), ethylene-vinyl-acetate, ethylene-methyl-acrylate, ethylene butyl acrylate, poly-propylene, atactic polypropylene, polystyrene, polyethylene, LDPE, HDPE, oxidized high density poly-propylene, poly-phosphoric acid (PPA), natural rubber, polybutadiene, epoxy resins, polyurethane resins, acrylic resins, phenolic resins, gilsonite, lignin, diblock polymers, Styrene-Butadiene-Styrene (SBS), triblock polymers which may be either linear or radial, styrene-isoprene-styrene (SIS), diblocked polymers, hydrotreated SBS, Styrene Ethylene Butadiene Styrene polymers (SEBS), Styrene Butadiene Rubber (SBR), polyacrylamide, and crumb rubber.

Polyethylene may be in powdered form. This powdered form may be finely ground or in divided form. Applicant recognized the problem with the fire and explosion hazards of addition of polyethylene in the powdered form. Blending polyethylene with ester bottoms reduces or eliminates the fire and explosion hazards associated with polyethylene. Additionally, blending polyethylene in powdered form with the asphalt is easier when the polyethylene is present as a mixture with ester bottoms.

Ester bottoms as used herein are a byproduct of methyl ester refining. Ester bottoms are a low value by-product of vegetable oil or animal fat refining to produce methyl ester. Ester bottoms are currently marketed for animal feed, lubricants, or other industrial uses at a low price point. The addition of ester bottoms provides refiners the opportunity to use low value byproduct waste of refining methyl ester. Feedstock containing all or a portion of vegetable oil or animal fats are reacted and refined to produce a variety of finished products including methyl esters, such as biodiesel. Out of the variety of finished products produced from methyl esters, on the low end of the value spectrum are ester bottoms. Ester bottoms are a residual byproduct of refining biodiesel and are not glycerin or skimmed fatty acids. As such, ester bottoms may contain one or more methyl esters, sodium soap, monoglycerides, diglycerides, triglycerides, or unsaponifiables. The unsaponifiables may make up about 10% of the ester bottoms. The unsaponifiables may make up at least 10% of the ester bottoms. Additionally, ester bottoms may have a viscosity range 10-900 centipoise (cP) at 64 degrees Celsius (° C.).

In certain embodiments, the method of manufacturing ester bottoms includes reacting methanol and dry oil to generate reaction products, which include at least methyl ester and glycerin. The dry oil is an oil that is at least partially dried to remove moisture therefrom prior to reaction with the methanol. The dry oil can be derived from one or more of a vegetable oil or an animal fat. The method further includes the steps of settling the glycerin from the reaction products, creating a distillation feedstock that has at least a portion of the glycerin removed from the reaction products, distilling the distillation feedstock, and recovering the distillation bottoms as ester bottoms. The ester bottoms thus produced are blended with polyethylene.

In certain embodiments, the method of manufacturing ester bottoms includes reacting methanol with dry oil containing one or more of a vegetable oil or an animal fat to generate reaction products with at least methyl ester and glycerin, settling the glycerin from the reaction products, removing at least a portion of the glycerin from the reaction products to leave an ester phase, distilling the ester phase to separate purified methyl esters from ester bottoms. The ester bottoms thus produced are blended with polyethylene. The reaction of methanol and the dry oil may occur in a multistage continuous reactor and methoxide catalyst may be added to one or more stages of the multistage continuous reactor.

In certain embodiments, the method of manufacturing ester bottoms includes reacting methanol with dry oil containing one or more of a vegetable oil or an animal fat to generate reaction products with at least methyl ester and glycerin, settling the glycerin from the reaction products, removing at least a portion of the glycerin from the reaction products to leave an ester phase, washing the ester phase with water to remove one or more of soap, methanol, catalyst or additional glycerin, drying the washed ester phase to define dried methyl esters, and distilling the dried methyl esters to separate purified methyl esters from ester bottoms. The ester bottoms thus produced are blended with polyethylene.

In certain embodiments, the method of manufacturing ester bottoms includes removing moisture from a feedstock containing all or a portion of vegetable oil or animal fats using a dryer to produce a dry oil. The dry oil is then fed into a three-stage continuous reactor/settler system where methoxide catalyst and methanol are added to each stage. In the settler system, methanol reacts with the dry oil to produce methyl ester and glycerin. The dry oil is reacted to less than 1% monoglyceride and virtually negligible diglycerides or triglycerides as it leaves the last settler. Glycerin settles out of the reaction mixture and is directed from the reactors downstream for further refining. As such, the ester phase remains after the glycerin is removed. The ester phase is then transferred to a single stage flash distillation tank to remove any remaining methanol. Next, the ester phase is water washed to remove glycerin, soap, methanol, and the methoxide catalyst to produce a washed methyl ester. The washed methyl esters are then dried under vacuum in an ester dryer to remove more methanol and water. Sodium methoxide is next added to the ester dryer to convert any glycerin and monoglycerides into diglycerides and triglycerides. The methyl esters then leave the ester dryer and are preheated before entering an ester surge tank. These methyl esters from the ester surge tank are then distilled to separate the purified methyl esters from the ester bottoms. The ester bottoms are next transferred from the distillation tower to an ester bottoms surge tank while the purified methyl ester is transferred from the distillation tower to a storage tank for distribution or sale. Ester bottoms may be used as a rejuvenator for asphalt. The ester bottoms, when added to an asphalt paving composition, help improve the useable temperature range.

Embodiments include methods of making a polyethylene-ester bottoms modified asphalt composition containing about 80 wt. % to about 99 wt. % of unmodified asphalt and about 1 wt. % to about 20 wt. % of the polyethylene-ester bottoms mixture. One such method includes the steps of obtaining a distillation bottoms of a distilled methyl ester product that results from reaction between methanol and at least one of vegetable oil or animal fat from which glycerin is settled and removed from the methyl ester product prior to distillation, whereby the distillation bottoms is defined as ester bottoms. The method further includes blending the ester bottoms with polyethylene to form a polyethylene ester bottoms mixture containing about 0.5 wt. % to about 75 wt. % of polyethylene and mixing the polyethylene-ester bottoms mixture with a polymer modified asphalt to produce a polyethylene-ester bottoms modified asphalt composition containing about 1 wt. % to about 20 wt. % of the polyethylene-ester bottoms mixture.

Embodiments include methods of making a polyethylene-ester bottoms modified asphalt composition containing about 95 wt. % to about 99 wt. % of unmodified asphalt and about 1 wt. % to about 5 wt. % of the polyethylene-ester bottoms mixture. One such method includes the steps of obtaining a distillation bottoms of a distilled methyl ester product that results from reaction between methanol and at least one of vegetable oil or animal fat from which glycerin is settled and removed from the methyl ester product prior to distillation, whereby the distillation bottoms is defined as ester bottoms. The method further includes blending the ester bottoms with polyethylene to form a polyethylene ester bottoms mixture containing about 25 wt. % to about 75 wt. % of polyethylene and mixing the polyethylene-ester bottoms mixture with a polymer modified asphalt to produce a polyethylene-ester bottoms modified asphalt composition containing about 1 wt. % to about 5 wt. % of the polyethylene-ester bottoms mixture.

In certain embodiments, a polyethylene-ester bottoms modified asphalt may contain about 1 wt. % to about 18 wt. % of polyethylene-ester bottoms mixture, or about 1 wt. % to about 16 wt. %, or about 1.5 wt. % to about 14 wt. %, or about 1.5 wt. % to about 12 wt. %, or about 1.5 wt. % to about 10 wt. %, or about 1.5 wt. % to about 8 wt. %, or about 2 wt. % to about 6 wt. %, or about 2 wt. % to about 4 wt. %.

The polyethylene-ester bottoms modified asphalt contains about 80 wt. % to about 99 wt. % of the unmodified asphalt. In certain embodiments, a polyethylene-ester bottoms modified asphalt may contain about 80 wt. % to about 97 wt. % of unmodified asphalt, or about 80 wt. % to about 95 wt. %, or about 80 wt. % to about 93 wt. %, or about 80 wt. % to about 91 wt. %, or about 80 wt. % to about 89 wt. %, or about 80 wt. % to about 87 wt. %, or about 90 wt. % to about 99 wt. %, or about 93 wt. % to about 99 wt. %.

Ester bottoms are one of many different types of asphalt binder modifiers that may be used in polyethylene modified asphalt. In certain embodiments, compositions contain unmodified asphalt and a mixture of polyethylene and soybean oil byproducts. Soybean oil or soy oil is a most widely used vegetable oil for both edible and industrial uses. The most common ester of soybean oil is methyl ester. As such, polyethylene may be blended with a byproduct of soybean oil or soy oil processing. Certain embodiments of the polyethylene-soy oil modified asphalt may contain about 1 wt. % to about 20 wt. % of a mixture of polyethylene and a byproduct of soybean oil or soy oil. Certain embodiments of the polyethylene-soy oil modified asphalt may contain about 1 wt. % to about 5 wt. % of a mixture of polyethylene and a byproduct of soybean oil or soy oil.

In certain embodiments, compositions contain unmodified asphalt and a mixture of polyethylene and corn oil byproducts. Corn oil is also a widely used vegetable oil that may be refined to produce a variety of finished products, including methyl esters. Polyethylene may also be blended with a byproduct of corn oil processing. Certain embodiments of the polyethylene-corn oil modified asphalt may contain about 1 wt. % to about 20 wt. % of the mixture of polyethylene and the byproduct of corn oil. Certain embodiments of the polyethylene-corn oil modified asphalt may contain about 1 wt. % to about 5 wt. % of the mixture of polyethylene and the byproduct of corn oil.

Methods of producing the polyethylene-ester bottoms modified asphalt effects the amount of increase in the low temperature compliance of polyethylene-ester bottoms modified asphalt compared to the low temperature compliance of unmodified asphalt. As described herein, blending the polyethylene with the ester bottoms prior to mixing with asphalt, improves the low temperature compliance of the asphalt while also maintaining the PG grade of the polyethylene-ester bottoms modified asphalt.

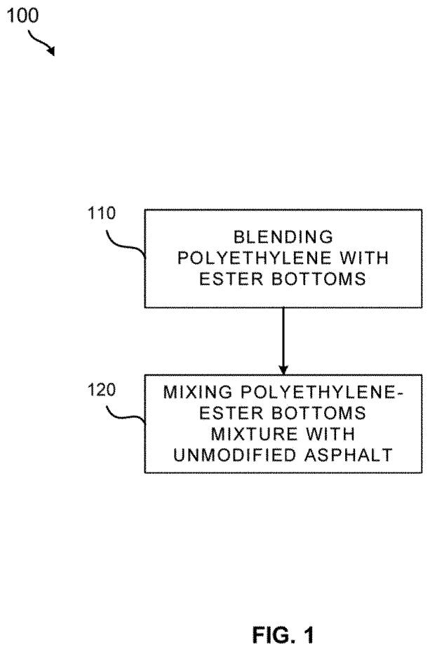

FIG. 1 is an illustrative flow diagram of method 100 for producing polyethylene-ester bottoms modified asphalt. The method includes the step 110 of blending polyethylene with ester bottoms to form a polyethylene-ester bottoms mixture. The polyethylene-ester bottoms mixture contains about 0.5 wt. % to about 75 wt. % of the polyethylene. The ester bottoms contained in the mixture is a byproduct of methyl ester refining. The ester bottoms may contain one or more of methyl esters, sodium soap, monoglycerides, diglycerides, triglycerides, or unsaponifiables. Unsaponifiables may make up about 10 wt. % of the ester bottoms. The unsaponifiables may make up at least 10% of the ester bottoms.

Blending of the polyethylene with the ester bottoms may occur at a temperature ranging from about 15° C. to about 24° C. for a time period ranging from about 10 minutes to about 30 minutes. Other factors may be used to determine sufficient mixture are those as understood by those in the art.

In a subsequent step 120, the method includes mixing the polyethylene-ester bottoms mixture with an unmodified asphalt to produce a polyethylene-ester bottoms modified asphalt. The polyethylene-ester bottoms modified asphalt may contain about 80 wt. % to about 99 wt. % of the unmodified asphalt. The polyethylene-ester bottoms modified asphalt may also contain about 1 wt. % to about 20 wt. % of the polyethylene-ester bottoms mixture.

The method may include supplying the polyethylene-ester bottoms mixture to a vessel containing the unmodified asphalt prior to mixing polyethylene-ester bottoms mixture with unmodified asphalt. Mixing the polyethylene-ester bottoms mixture with the unmodified asphalt may occur at a temperature range from about 15° C. to about 24° C. This step may take place for a time period from about 1 hour to about 2 hours. Other factors may be used to determine sufficient mixture are those as understood by those in the art.

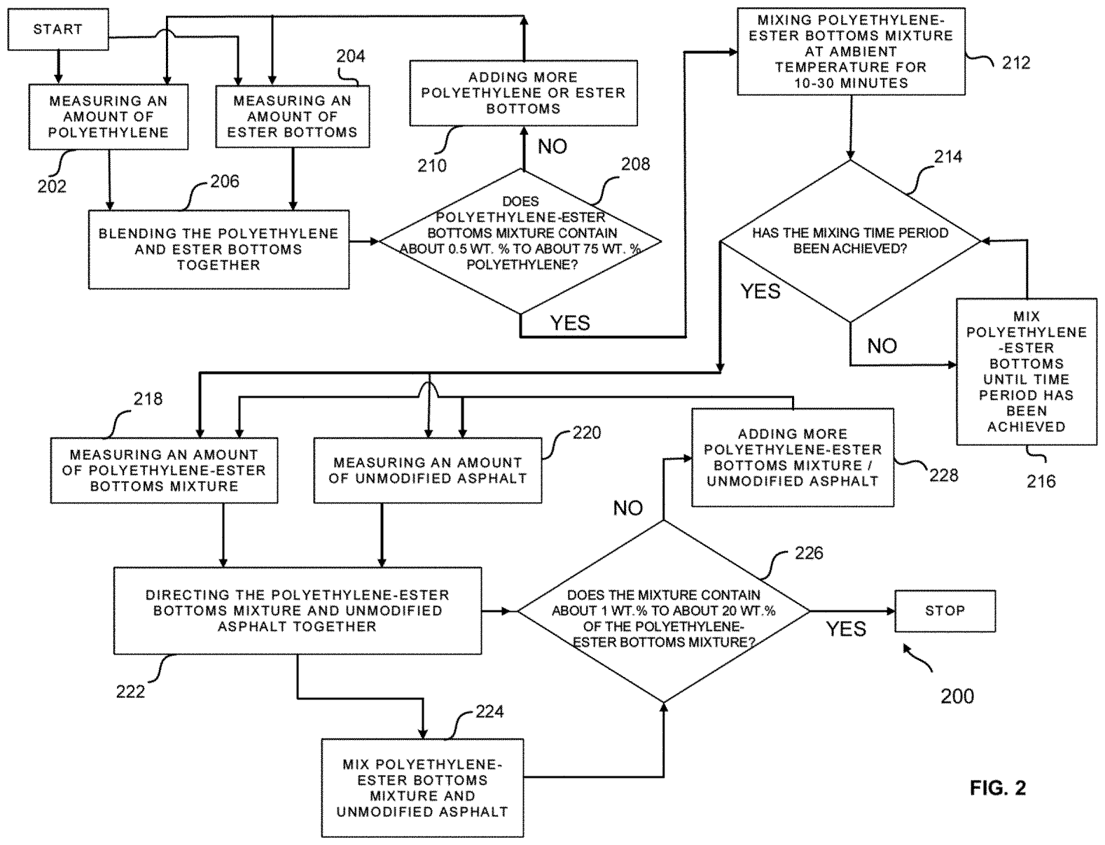

FIG. 2 is a diagrammatic representation of method 200 for the production of polyethylene-ester bottoms modified asphalt from polyethylene, ester bottoms, and unmodified asphalt, according to an embodiment of the disclosure. Embodiments of the method include the step 202, measuring an amount of polyethylene. In a concurrent or subsequent step 204, the method may include measuring an amount ester bottoms. The polyethylene may be added to a vessel that contains the ester bottoms in conventional amounts. Due to the fire and explosion hazards, the polyethylene may be added to the ester bottoms in small amounts.

The method may further include the step 206 of blending the polyethylene and the ester bottoms to produce a polyethylene-ester bottoms mixture. Polyethylene, alternatively, may be blended with a byproduct of soybean oil, soy oil, or corn oil. Those wishing to add a large amount of polyethylene to the ester bottoms may add a large amount of polyethylene to the polyethylene-ester bottoms mixture.

The method may further include the step 208 of determining whether the polyethylene-ester bottoms mixture contains about 0.5 wt. % to about 75 wt. % of polyethylene. If the polyethylene-ester bottoms mixture does not contain the correct amount of polyethylene, the method may include the step 210 of adding more polyethylene or ester bottoms to the polyethylene-ester bottoms mixture by repeating the steps 202, 204, 206, and 208.

If the polyethylene-ester bottoms mixture does contain the correct amount of polyethylene, the method may further include the step 212 of mixing the polyethylene and ester bottoms at an ambient temperature for a time period of about 10 minutes to about 30 minutes. Ambient temperature may include a temperature range of about 15° C. to about 24° C.

The method may further include the step 214 of determining whether the polyethylene-ester bottoms has been mixed for about 10 minutes to about 30 minutes. If the polyethylene-ester bottoms mixture has not been mixed for about 10 to about 30 minutes, the method may include step 216 of mixing the polyethylene-ester bottoms mixture until the time period has been achieved. The time period may also be determined by the amount of polyethylene-ester bottoms mixture being mixed and other factors.

If the polyethylene-ester bottoms mixture has been mixed for the time period and meets other factors used to determine whether the polyethylene-ester bottoms is sufficiently mixed, the method may further include the step 218 of measuring an amount of the polyethylene-ester bottoms mixture. The amount of polyethylene-ester bottoms mixture used to mix with the unmodified asphalt would maintain the high temperature compliance and improve the low temperature compliance of the asphalt. In a concurrent or subsequent step 220, the method may also include measuring an amount of unmodified asphalt.

The method may further include the step 222 of directing the polyethylene-ester bottoms mixture and unmodified asphalt together. The polyethylene-ester bottoms mixture may be directed into a vessel containing the unmodified asphalt. In a subsequent step 224, the method may include mixing the polyethylene-ester bottoms mixture and the unmodified asphalt to produce polyethylene-ester bottoms modified asphalt. The polyethylene-ester bottoms may be injected into the unmodified asphalt at a controlled rate.

The method may further include the step 226 of determining whether the polyethylene-ester bottoms modified asphalt contains a predetermined amount of the polyethylene-ester bottoms mixture, such as, about 1 wt. % to about 20 wt. % of the polyethylene-ester bottoms mixture. The polyethylene-ester bottoms modified asphalt may contain about 5 wt. % to about 20 wt. % of the polyethylene-ester bottoms mixture. The polyethylene-ester bottoms modified asphalt may contain about 10 wt. % to about 20 wt. % of the polyethylene-ester bottoms mixture.

If it is determined that the polyethylene-ester bottoms modified asphalt does not contain about 1 wt. % to about 20 wt. % of the polyethylene-ester bottoms mixture, the method may include the step 228 of adding more polyethylene-ester bottoms mixture or unmodified asphalt by repeating the steps 218, 220, 222, and 224 until the polyethylene-ester bottoms modified asphalt contains about 1 wt. % to about 20 wt. % of the polyethylene-ester bottoms mixture. The polyethylene-ester bottoms may be injected into the unmodified asphalt at a controlled rate until the mixture contains about 1 wt. % to about 20 wt. % of the polyethylene-ester bottoms mixture.

In certain embodiments, a method of producing a polyethylene-ester bottoms modified asphalt includes mixing polyethylene-ester bottoms mixture that contains polyethylene and ester bottoms with an unmodified asphalt to produce a polyethylene-ester bottoms modified asphalt. The polyethylene-ester bottoms modified asphalt contains about 1 wt. % to about 20 wt. % of the polyethylene-ester bottoms mixture. In other embodiments, polyethylene-ester bottoms modified asphalt may contain about 1 wt. % to about 5 wt. % of the polyethylene-ester bottoms mixture.

The polyethylene-ester bottoms mixture may contain about 0.5 wt. % to about 75 wt. % of the polyethylene. In certain embodiments, a polyethylene-ester bottoms mixture may contain about 1 wt. % to about 65 wt. % of polyethylene, or about 5 wt. % to about 65 wt. %, or about 10 wt. % to about 75 wt. %, or about 15 wt. % to about 65 wt. %, or about 20 wt. % to about 75 wt. %, or about 25 wt. % to about 65 wt. %, or about 30 wt. % to about 70 wt. %, or about 35 wt. % to about 65 wt. %, or about 40 wt. % to about 70 wt. %, or about 45 wt. % to about 65 wt. %, or about 40 wt. % to about 60 wt. %, or about 45 wt. % to about 55 wt. %.

The polyethylene-ester bottoms mixture may contain about 25 wt. % to about 99.5 wt. % of the ester bottoms. In certain embodiments, a polyethylene-ester bottoms mixture may contain about 30 wt. % to about 90 wt. % of ester bottoms, or about 35 wt. % to about 85 wt. %, or about 40 wt. % to about 80 wt. %, or about 45 wt. % to about 75 wt. %, or about 45 wt. % to about 70 wt. %, or about 45 wt. % to about 65 wt. %, or about 45 wt. % to about 55 wt. %, or about 50 wt. % to about 55 wt. %.

The ester bottoms, as used herein, are a byproduct of methyl ester refining. The ester bottoms have a viscosity range of 10-900 cP at 64° C. As such, the ester bottoms may contain one or more of methyl esters, sodium soap, monoglycerides, diglycerides, triglycerides, or unsaponifiables. The unsaponifiables may make up about 10 wt. % of the ester bottoms.

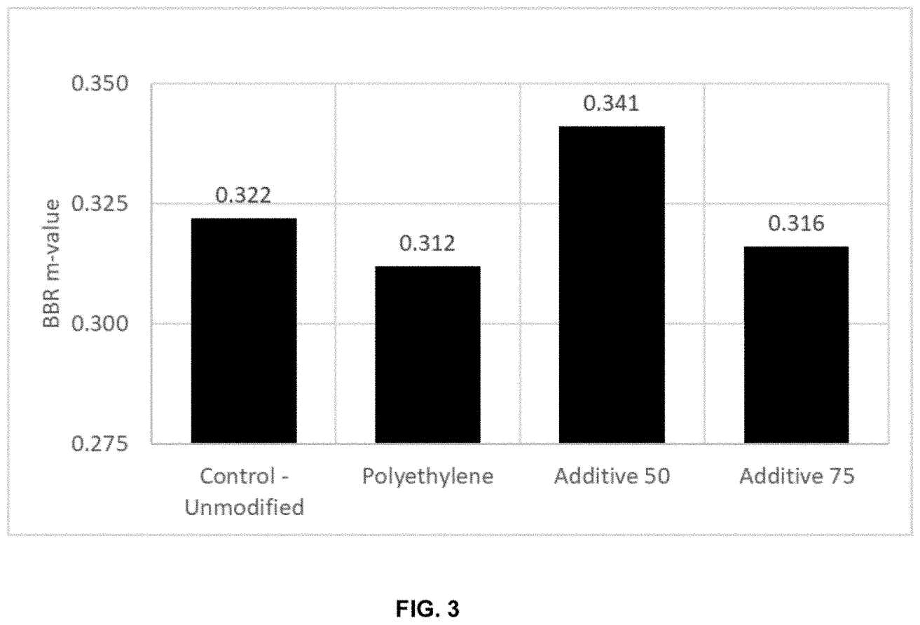

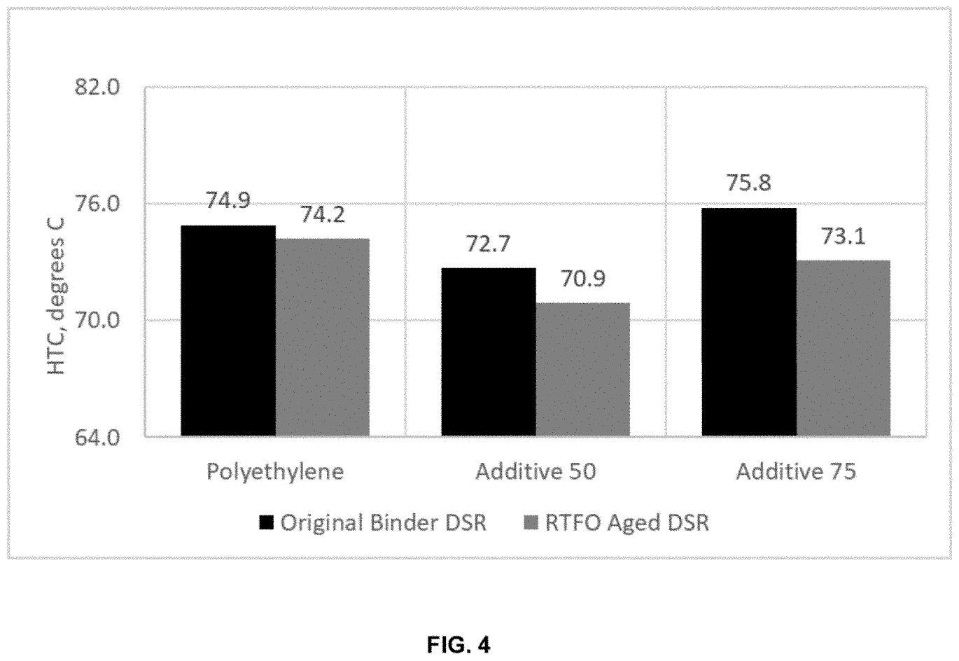

Determining the high and low temperature range compliance of asphalt helps the understanding of how the asphalt will respond to stresses at low and high temperature. High temperature compliance (HTC) may be measured using original binder (OB) (unaged binder) and short-term aged binder (rolling thin-film oven (RTFO) aged). Low temperature compliance may be measured by the m-value, the rate at which the asphalt binder stiffness changes over time, as will be understood by those skilled in the art. FIG. 3 is a graphical representation of a comparison of m-values of unmodified asphalt, polyethylene modified asphalt, and polyethylene-ester bottoms modified asphalt in two different ratios of polyethylene to ester bottoms. FIG. 4 is a graphical representation of a comparison of high temperature compliance of polyethylene modified asphalt and polyethylene-ester bottoms modified asphalt measured as original binder (unaged binder) and rolling thin-film oven aged binders with the polyethylene-ester bottoms modified asphalt in two different ratios of polyethylene to ester bottoms. Mixing the polyethylene-ester bottoms mixture with the unmodified asphalt increases the low temperature compliance of the unmodified asphalt and does not substantially affect, within acceptable experimental error, the high temperature compliance of the unmodified asphalt. Although there may be changes in the high and low temperature compliance of the asphalt with the addition of polyethylene-ester bottoms mixture, the UTR performance grading of the polyethylene-ester bottoms modified asphalt remains the same as the unmodified asphalt.

As such, high temperature compliance and low temperature compliance were measured with two modified samples. The sample labeled Additive 50 in FIG. 3 is a polyethylene-ester bottoms modified asphalt composition that contains about 4 wt. % of the polyethylene-ester bottoms mixture and about 96 wt. % of the unmodified asphalt. The polyethylene and the ester bottoms are present at about 50 wt. % each in the mixture of polyethylene-ester bottoms. The Additive 50 sample was produced according to the methods described herein. The sample labeled Additive 75 in FIG. 3 is a polyethylene-ester bottoms modified asphalt composition that contains about 2.7 wt. % of the polyethylene-ester bottoms mixture and about 97.3 wt. % of the unmodified asphalt. The polyethylene and the ester bottoms are present at about 75 wt. % and 25 wt. % each in the mixture of polyethylene-ester bottoms. Additive 75 that was also produced according to the methods described herein.

FIG. 3 is a graphical representation of a comparison of m-values of unmodified asphalt, polyethylene modified asphalt that contains about 2 wt. % of the polyethylene and about 98 wt. % of the unmodified asphalt, and the two variations of polyethylene-ester bottoms modified asphalt—Additive 50 and Additive 75. At low temperatures, asphalt binder becomes stiffer and more brittle and thus, it becomes more susceptible to fracture and cracking. The m-value measures the rate at which the asphalt binder stiffness changes over time. The m-value is used to determine low temperature compliance. A higher m-value is an indication that the stiffness may not increase as quickly when temperature decreases. This means the tensile stresses are smaller as the contraction occurs, reducing the chances of cracking of the asphalt. Thus, the higher the m-value, the better the asphalt's low temperature compliance.

An essential factor in performance of asphalt concrete pavements is its elastic-stiffness properties. The stiffness modulus of asphalt mixtures is fundamental to the analysis of the stress—strain response of pavement under traffic loading. Stiffness is measured by a three point bending test. The m-value is the slope of the curve from a plot of the log of creep stiffness versus the log of the time in a mid-span beam rheometer deflection study according to American Association of State Highway Transportation (AASHTO) T313-2020, Standard Method of Test for Determining the Flexural Creep Stiffness of Asphalt Binders Using the Bending Beam Rheometer (BBR). BBR is the testing technique for measuring low-temperature compliance characteristics of asphalt binders. The BBR test method covers the determination of the low-temperature flexural creep stiffness of the asphalt binder. The testing method includes an asphalt sample beam that is placed in a cold fluid bath. The asphalt beam is then loaded by applying a constant load to the midpoint of the beam. From the measured deflection of the specimen, the flexural creep stiffness is calculated from the actual load and the actual specimen dimensions.

As shown in FIG. 3, polyethylene mixed with unmodified asphalt has the lowest m-value. However, the polyethylene-ester bottoms mixture blended with the unmodified asphalt helps improved the low temperature compliance properties of the asphalt. An m-value lower than 0.300 is considered to be the failure point. The addition of polyethylene decreases the m-value. Thus, the sample with polyethylene had an m-value closest to 0.300. However, the addition of ester bottoms improved the m-value when blended with polyethylene prior to mixing with asphalt. The Additive 50 sample had the substantially larger increase in m-value. Thus, the Additive 50 sample (polyethylene-ester bottoms modified asphalt composition that contains polyethylene and ester bottoms present in 50:50 weight percent ratio in a mixture of polyethylene-ester bottoms) had a comparatively better low temperature compliance. Also, the Additive 75 sample (polyethylene-ester bottoms modified asphalt composition that contains polyethylene and ester bottoms present in 75:25 weight percent ratio in a mixture of polyethylene-ester bottoms) had better low temperature compliance as compared to polyethylene modified asphalt. In certain embodiments, a low temperature compliance of the polyethylene-ester bottoms modified asphalt as measured by a m-value may be up to 10% greater than a low temperature compliance of a polyethylene modified asphalt.

In certain embodiments, the polyethylene-ester bottoms mixture contains about 50 wt. % of the polyethylene. As such, a low temperature compliance of the polyethylene-ester bottoms modified asphalt as measured by a m-value is about 5% greater, within acceptable experimental error, than a low temperature compliance of a polyethylene modified asphalt. In certain embodiments, the polyethylene-ester bottoms mixture contains about 75 wt. % of the polyethylene. Thus, a low temperature compliance of the polyethylene-ester bottoms modified asphalt as measured by a m-value is about 1% greater, within acceptable experimental error, than a low temperature compliance of a polyethylene modified asphalt.

High temperature compliance measurement is equivalent to continuous grade, is measured according to ASTM-D7643-16, Standard Practice for Determining the Continuous Grading Temperatures and Continuous Grades for PG Graded Asphalt Binders. Inclusion of the renewable and/or recyclable products, such as ester bottoms, does not substantially affect the high temperature compliance of the polyethylene-ester bottoms modified asphalt as compared to the polyethylene modified asphalt. For example, the grade of the polyethylene-ester bottoms modified asphalt was maintained at PG76, even when renewable components like ester bottoms and byproducts of soy oil or corn oil are used in the asphalt compositions.

FIG. 4 is a graphical representation of a comparison of high temperature compliance of polyethylene modified asphalt and polyethylene-ester bottoms modified asphalt measured as original binder (unaged binder) and rolling thin-film oven aged binders with the polyethylene-ester bottoms modified asphalt in two different ratios of polyethylene to ester bottoms. Both the Additive 50 and Additive 75 samples demonstrated reduced high temperature compliance. But, both these samples maintained the PG76 grade. As such, in some embodiments, the methods and compositions may be suitable as a safer alternative to polyethylene modified asphalt.

When ranges are disclosed herein, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

This application claims priority to, and the benefit of U.S. Provisional Application No. 63/265,551, filed Dec. 16, 2021, titled “POLYETHYLENE-MODIFIED ASPHALT METHODS AND COMPOSITONS FOR ENHANCING LOW TEMPERATURE PERFORMANCE,” the disclosure of which is incorporated herein by reference in its entirety.

In the drawings and specification, several embodiments of methods and compositions for the production of polyethylene-ester bottoms modified asphalt have been disclosed, and although specific terms are employed, the terms are used in a descriptive sense only and not for purposes of limitation. Embodiments of systems and methods have been described in considerable detail with specific reference to the illustrated embodiments. However, it will be apparent that various modifications and changes may be made within the spirit and scope of the embodiments of methods and compositions as described in the foregoing specification, and such modifications and changes are to be considered equivalents and part of this disclosure.

What is claimed is:

1. A method of producing a polyethylene-ester bottoms modified asphalt, the method comprising:
blending polyethylene with ester bottoms to form a polyethylene-ester bottoms mixture containing about 0.5 weight percent (wt. %) to about 75 wt. % of the polyethylene; and
mixing the polyethylene-ester bottoms mixture with an unmodified asphalt to produce a polyethylene-ester bottoms modified asphalt.

2. The method of claim 1, wherein the ester bottoms are a byproduct of methyl ester refining.

3. The method of claim 1, further comprising:
reacting methanol and dry oil to generate reaction products, the reaction products including at least methyl ester and glycerin, the dry oil including one or more of a vegetable oil or an animal fat that has at least some moisture removed therefrom prior to reaction with the methanol;
removing at least a portion of the glycerin from the reaction products to leave an ester phase; and
distilling the ester phase to separate purified methyl esters and recover distillation bottoms as the ester bottoms.

4. The method of claim 1, wherein the polyethylene-ester bottoms modified asphalt contains about 80 wt. % to about 99 wt. % of the unmodified asphalt and about 1 wt. % to about 20 wt. % of the polyethylene-ester bottoms mixture.

5. The method of claim 1, wherein the ester bottoms contain one or more of methyl esters, monoglycerides, diglycerides, triglycerides, or unsaponifiables.

6. The method of claim 1, wherein the polyethylene-ester bottoms mixture contains about 50 wt. % of the polyethylene.

7. The method of claim 1, wherein a low temperature compliance of the polyethylene-ester bottoms modified asphalt as measured by a m-value is up to 10% greater than a low temperature compliance of a polyethylene modified asphalt.

8. The method of claim 1, wherein the polyethylene-ester bottoms mixture contains about 75 wt. % of the polyethylene.

9. The method of claim 1, wherein the polyethylene is blended with the ester bottoms at a temperature ranging from about 15 degrees Celsius (° C.) to about 24° C.

10. A method of producing a polyethylene-ester bottoms modified asphalt, the method comprising:
mixing a polyethylene-ester bottoms mixture that contains polyethylene and ester bottoms with an unmodified asphalt to produce a polyethylene-ester bottoms modified asphalt containing about 1 wt. % to about 20 wt. % of the polyethylene-ester bottoms mixture.

11. The method of claim 10, wherein the polyethylene-ester bottoms mixture contains about 0.5 wt. % to about 75 wt. % of the polyethylene.

12. The method of claim 10, wherein the ester bottoms are a byproduct of methyl ester refining.

13. The method of claim 10, further comprising:
reacting methanol and dry oil to generate reaction products, the reaction products including at least methyl ester and glycerin, the dry oil including one or more of a vegetable oil or an animal fat that has at least some moisture removed therefrom prior to reaction with the methanol;
removing at least a portion of the glycerin from the reaction products to leave an ester phase; and
distilling the ester phase to separate purified methyl esters and recover distillation bottoms as ester bottoms.

14. The method of claim 10, wherein the ester bottoms contain one or more of methyl esters, monoglycerides, diglycerides, triglycerides, or unsaponifiables.

15. The method of claim 10, wherein the polyethylene-ester bottoms mixture contains about 50 wt. % of the polyethylene.

16. The method of claim 15, wherein a low temperature compliance of the polyethylene-ester bottoms modified asphalt as measured by a m-value is up to 10% greater than a low temperature compliance of a polyethylene modified asphalt.

17. The method of claim 10, wherein the polyethylene-ester bottoms mixture contains about 75 wt. % of the polyethylene.

18. A polyethylene-ester bottoms modified asphalt composition comprising about 80 wt. % to about 99 wt. % of an unmodified asphalt and about 1 wt. % to about 20 wt. % of a polyethylene-ester bottoms mixture.

19. The composition of claim 18, wherein the ester bottoms are obtained as distillation bottoms of a distilled methyl ester product that results from reaction between methanol and at least one of vegetable oil or animal fat from which glycerin is settled and removed from the methyl ester product prior to distillation.

20. The composition of claim 18, wherein the polyethylene-ester bottoms mixture contains about 50 wt. % of the polyethylene.
